(19) United States
(12) Patent Application Publication
(10) Pub. No.: US 2012/0163191 A1
(43) Pub. Date: Jun. 28, 2012

(54) NETWORK STATE MONITORING SYSTEM

(75) Inventors: Daishi TOKIMIZU, Tokyo (JP); Kazuo Masuhama, Tokyo (JP)

(73) Assignee: Mitsubishi Electric Corporation, Chiyoda-ku (JP)

(21) Appl. No.: 13/207,703

(22) Filed: Aug. 11, 2011

(30) Foreign Application Priority Data
Dec. 22, 2010 (JP) 2010-282926

(51) Int. Cl. H04L 12/26

(52) U.S. Cl. 370/242

(57) ABSTRACT

A delay time of each node is acquired at a source node, and whether the acquired delay time is normal or abnormal is automatically recognized, thereby enabling an abnormal node to be detected in the source node. A test packet is transmitted from the source node to the destination node through the respective relay nodes, a relay delay time of each relay node, which has been measured in the each relay node, is added to the test packet, the source node is designated as a destination of the test packet received in the destination node to return a test response packet, the relay delay time of the each node is extracted from the test response packet received in the source node that has received the test response packet, and an abnormal node is detected by an abnormal state detector disposed in the source node according to the extracted relay delay time of the each node.

### BACKGROUND OF THE INVENTION

1. Field of the Invention

The present invention relates to a state monitoring system that monitors a network state to specify a faulty portion.

2. Background Art

As a method of monitoring a network state, Patent Literature 1 discloses a method in which a test packet is transmitted toward an arbitrary destination node from an arbitrary source node through a relay node via a data exchange network to grasp the network state. The relay node and the destination node that have received the test packet each sequentially record an address when passing through the node and a passage time in the test packet. The source node that has received the transmitted test packet can grasp and indicate a time required by each node according to data recorded in the test packet, and stores data about the network state in a storage device so as to grasp congestion between the respective nodes on the network.

Also, in Patent Literature 2, the relay node and the destination node that have received the transmitted test packet do not record the passage time in the test packet, but generate a passage notice packet in which the passage time is recorded, and transmit the passage notice packet to the source node. The source node receives the passage notice packet transmitted from each node, and accurately grasps a transmission elapsed time of the test packet and an inter-node transmission time from data recorded in the passage notice packet, thereby enabling congestion between the respective nodes of the network to be grasped.

In the methods of Patent Literatures 1 and 2, if clock times of the respective nodes are different from each other, the inter-node transmission time of the test packet cannot be accurately grasped. Under the circumstances, in Patent Literature 3, a delay time is calculated according to a difference between a time at which the test packet has been received by the relay packet, and a time at which the test packet has been transmitted from the relay packet, and the delay time of each node is recorded in the test packet. As a result, the congestion between the respective nodes of the network can be grasped even if the respective nodes are out of time synchronization with each other.

### CITATION LIST

### Patent Literature

Patent Literature 1: JP-A-2-7273
Patent Literature 2: JP-A-10-93563
Patent Literature 3: JP-T-2000-507779

However, in Patent Literature 3, because the test packet is not returned to the source node, the source node cannot monitor the network state. As usual, because the nodes connected to the network are arranged far from the source node, there is a need to monitor the network state in the source node.

Also, in the related art, even if the delay time of the test packet can be measured, delay times of a user packet and a network monitor packet cannot be measured. As usual, because the network monitor packet higher in priority than the user packet is transmitted and relayed in priority to the user packet at each node, the delay time is shorter than that of the user packet. Further, if the priority is different among the user packets, because there is a possibility that the delay time is different depending on a difference of the priority, the delay time of the packet cannot be measured in each priority in the related art.

Further, there is no means for automatically recognizing whether the acquired delay time is normal or abnormal, there arises such a problem that a failure that has transiently occurred in the network cannot be immediately detected.

### SUMMARY OF THE INVENTION

The present invention has been made in view of the above circumstances, and aims at providing a network state monitoring system that acquires a delay time of each node at a source node, and automatically recognizes whether the acquired delay time is normal or abnormal, thereby enabling an abnormal node to be detected in the source node.

According to the present invention, there is provided a network state monitoring system that monitors a state of a network that communicates between a source node and a destination node through a plurality of relay nodes, in which a test packet is transmitted from the source node to the destination node through the respective relay nodes, a relay delay time of each relay node, which has been measured in the each relay node, is added to the test packet, the source node is designated as a destination of the test packet received in the destination node to return a test response packet to the source node, the relay delay time of the each node is extracted from the test response packet received in the source node that has received the test response packet, and an abnormal node is detected by an abnormal state detector disposed in the source node according to the extracted relay delay time of the each node.

According to the present invention, in the network state monitoring system that monitors the state of the network that communicates between the source node and the destination node through the plurality of relay nodes, the test packet is transmitted from the source node to the destination node through the respective relay nodes, the relay delay time of each relay node, which has been measured in the each relay node, is added to the test packet, the source node is designated as a destination of the test packet received in the destination node to return the test response packet to the source node, the relay delay time of the each node is extracted from the test response packet received at the source node that has received the test response packet, and the abnormal node is detected by the abnormal state detector disposed at the source node according to the extracted relay delay time of the each node. With this configuration, the delay time of each of the relay and destination node is acquired at the source node, and whether the acquired delay time is normal or abnormal is automatically recognized with the result that the abnormal node can be detected at the source node.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram illustrating one configuration example of a network according to a first embodiment of the present invention;

FIG. 2 is a diagram illustrating an example of a packet format of a test packet (node #0) according to the first embodiment of the present invention;

FIG. 3 is a diagram illustrating an example of a packet format of a test packet (node #m) according to the first embodiment of the present invention;

FIGS. 4A to 4C are diagrams illustrating examples of a packet format of a test response packet according to the first embodiment of the present invention;

FIGS. 5A to 5C are diagrams illustrating examples of packet formats of a test packet and a test response packet each having a priority added thereto according to the first embodiment of the present invention;

FIG. 6 is a block diagram illustrating an example of an internal configuration of the node according to the first embodiment of the present invention;

FIG. 7 is a diagram illustrating an example of a state monitor database according to the first embodiment of the present invention;

FIG. 8 is a diagram illustrating a conceptual example of a method for specifying an abnormal node according to the first embodiment of the present invention;

FIG. 9 is a diagram illustrating a conceptual example of a method for specifying a transient abnormal node according to the first embodiment of the present invention;

FIG. 10 is a graph illustrating a conceptual example of a method for specifying the transient abnormal node according to the first embodiment of the present invention;

FIG. 11 is a diagram illustrating another configuration example of a network according to a second embodiment of the present invention;

FIGS. 12A and 12B are diagrams illustrating examples of a packet format of a test packet according to the second embodiment of the present invention;

FIG. 13 is a diagram illustrating an example of a packet format of a test response packet according to the second embodiment of the present invention;

FIG. 14 is a diagram illustrating still another configuration example of a network according to a third embodiment of the present invention;

FIGS. 15A and 15B are diagrams illustrating examples of a packet format of a test packet according to the third embodiment of the present invention; and

FIGS. 16A and 16B are diagrams illustrating examples of a packet format of a test response packet according to the third embodiment of the present invention;

### DETAILED DESCRIPTION OF THE PREFERRED EMBODIMENTS

### First Embodiment

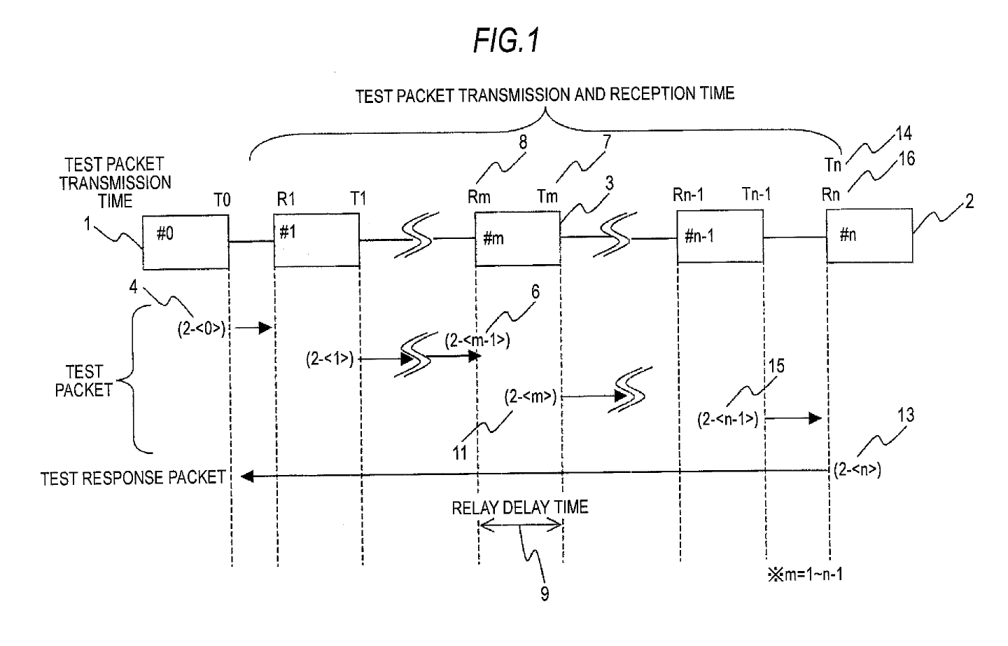

A network state monitoring system according to a first embodiment of the present invention will be described below with reference to FIGS. 1 to 10.

The first embodiment exemplifies a network state monitoring system in which a test packet is transmitted from a source node, which is a communication device that monitors a network state, to a destination node, which is a receiver device, through respective relay nodes, which are relay devices, a relay delay time is measured at each of the relay nodes and the destination node, the measured relay delay time is added to a test response packet, and at the source node, the test response packet is received, the relay delay time of each node is extracted from the test response packet, and an abnormal node is immediately detected by an abnormal state detector according to the extracted relay delay time of each node. The present invention is not limited to or by the first embodiment.

FIG. 1 is a diagram illustrating a configuration example of a network according to this embodiment, which is an illustrative diagram of the operation of acquiring the relay delay time of each node when the source node that monitors the communication state is a node (#0) 1 and the destination node is a node (#n) 2 as an example.

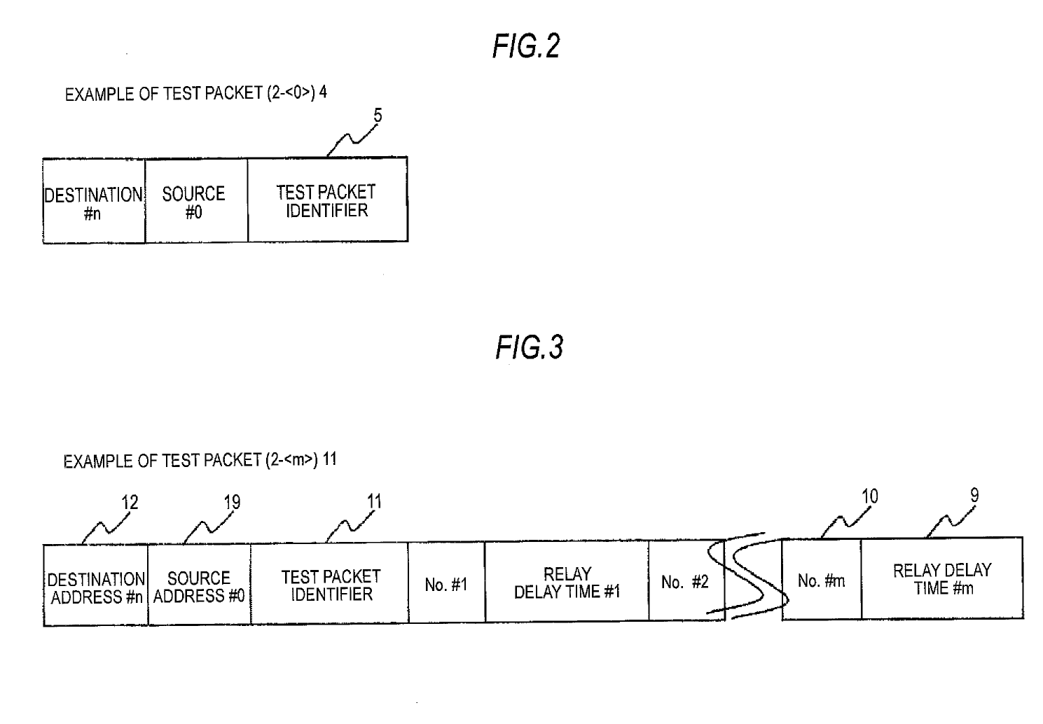

FIG. 2 is an illustrative diagram of an example of a packet format of the test packet transmitted by the source node (#0) 1 according to the first embodiment.

FIG. 3 is an illustrative diagram of an example of a packet format of the test packet relayed by a relay node (#m) 3 according to the first embodiment.

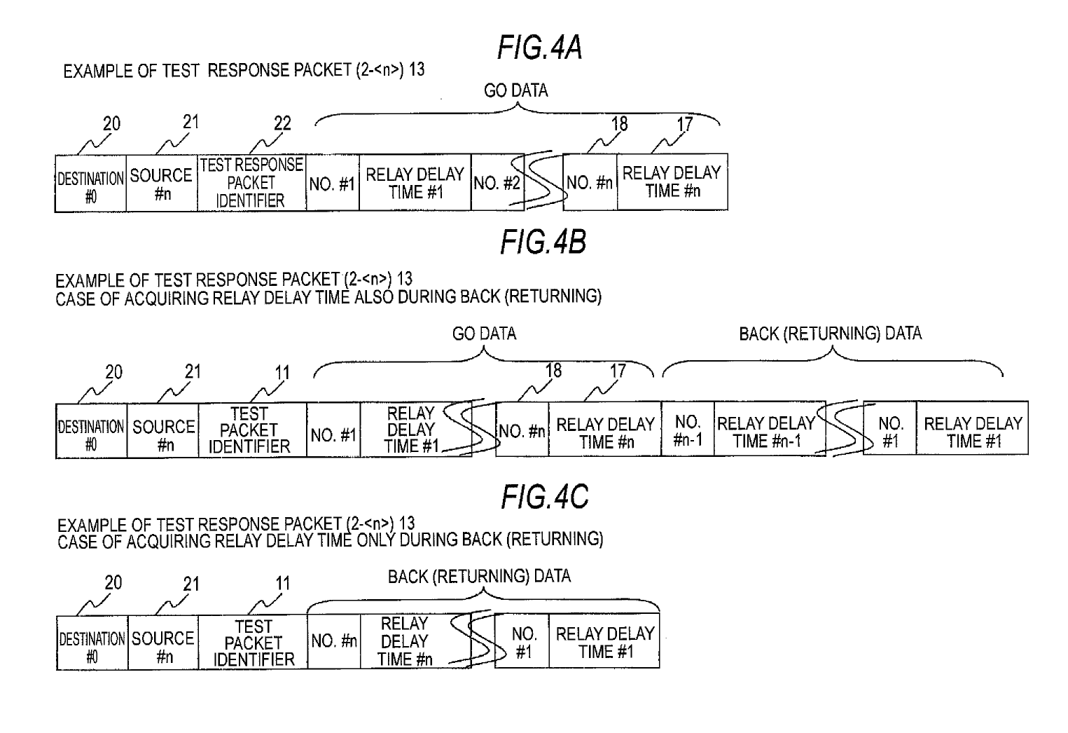

FIGS. 4A to 4C are illustrative diagrams of examples of the packet format of the test response packet returned by the destination node (#n) 2 according to the first embodiment.

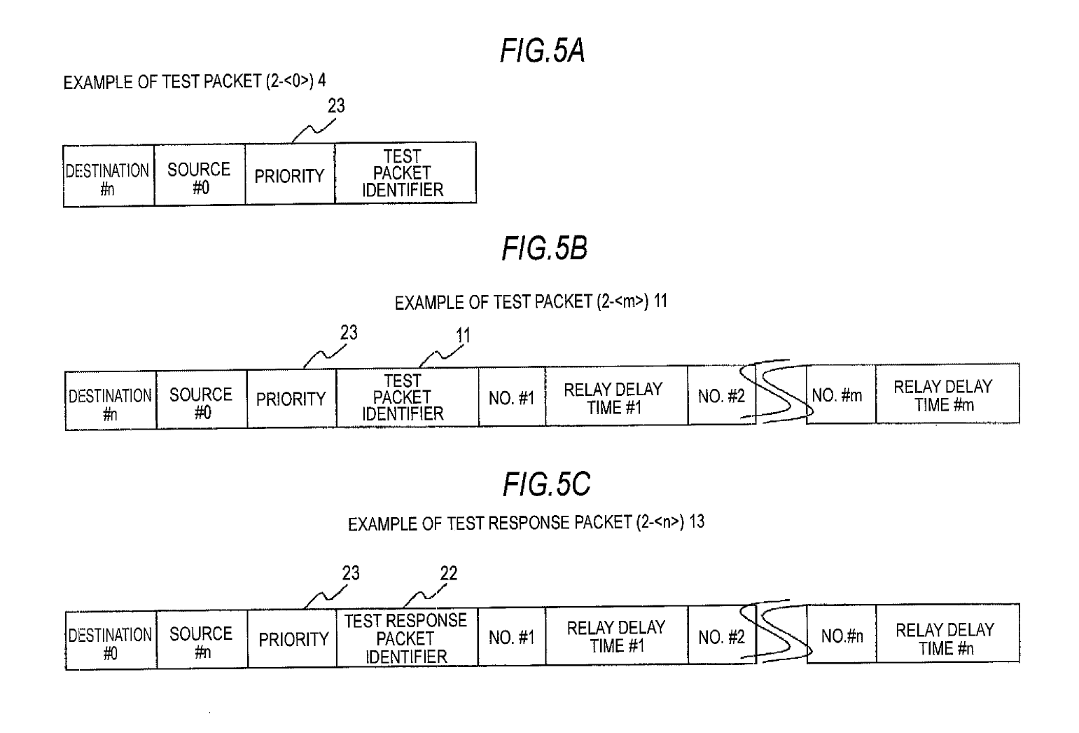

FIGS. 5A to 5C are illustrative diagrams of examples of the packet formats each having a priority added thereto according to the first embodiment.

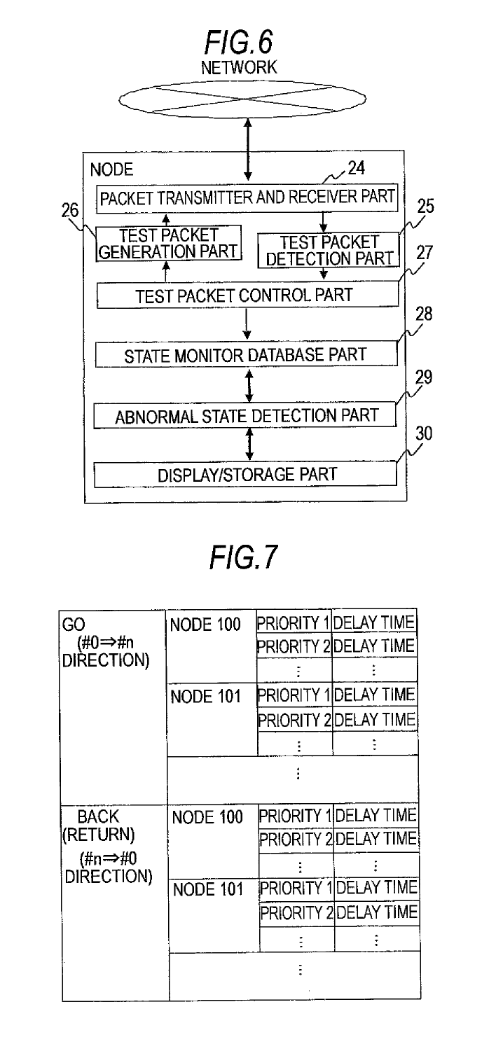

FIG. 6 is a block diagram illustrating an internal configuration of the node exemplified by the source node according to the first embodiment of the present invention.

FIG. 7 is an illustrative diagram of an example of a state monitor database part according to the first embodiment.

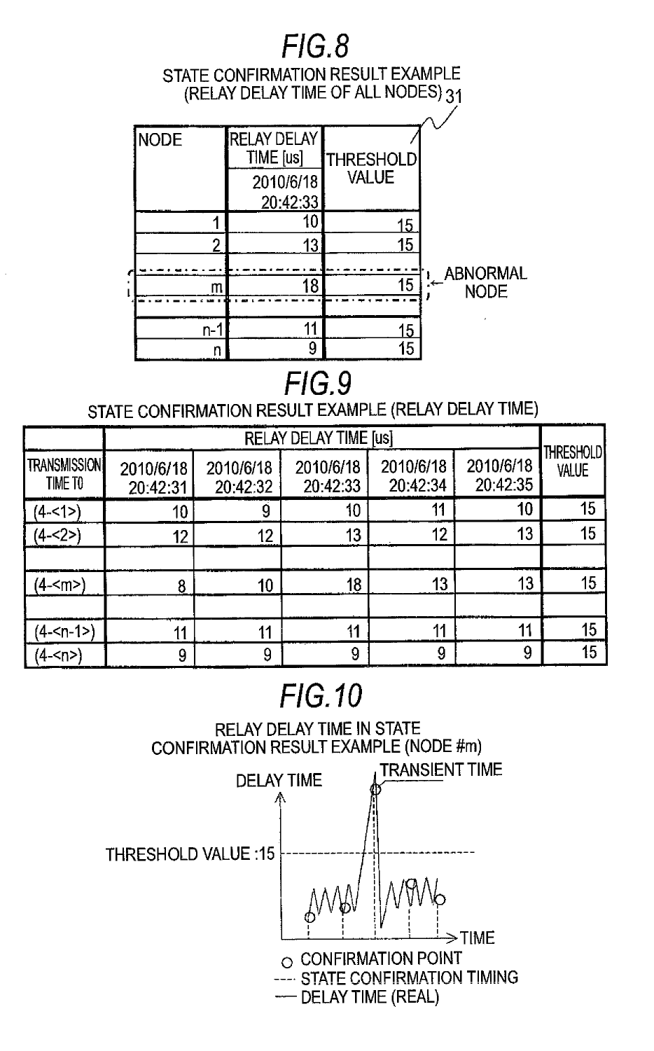

FIG. 8 illustrates the operation of detecting a node in which abnormality occurs on the basis of the acquired relay delay time according to the first embodiment.

FIGS. 9 and 10 illustrate the operation of detecting a node in which abnormality transiently occurs on the basis of the acquired relay delay time according to the first embodiment.

Subsequently, the operation of acquiring the relay delay time of each node from the source node that monitors the communication state will be described with reference to FIGS. 1 to 6.

Referring to FIG. 1, the source node (#0) 1 that monitors a network state transmits, to the destination node (#n) 2, a test packet (2-<0>) 4 having an identifier 5 added to a test packet having a destination address (#n) and a source address (#0) as illustrated in FIG. 2.

The test packet (2-<0>) 4 transmitted from the source node (#0) 1 passes through a first relay node (#1), a next relay node (#2) (not shown), . . . and the relay node (#m) 3 receives a test packet (2-<m−1>) 6 from a last relay node (#m−1) (not shown).

The relay node (#m) 3 that has received the test packet (2-<m−1>) 6 recognizes that the received packet is a test packet according to the test packet identifier 5 added at the source node (#0) 1. The relay node (#m) 3 then obtains a difference between a time Tm 7 when transmitting the test packet to a next relay node and a time Rm 8 when receiving the test packet (2-<m−1>) 6. The relay node (#m) 3 thus calculates a relay delay time (#m) 9 at its own node. The relay node (#m) 3 adds a node No. (#m) 10 and the relay delay time (#m) 9 to the test packet (2-<m−1>) 6 to generate a test packet (2-<m>) 11, and transmits the test packet (2-<m>) 11 to a next relay node. The entire operation of the above-mentioned relay node (#m) 3 is implemented by all of the relay nodes (m=1 to n−1).

The destination node (#n) 2 that has received a test packet (2-<n−1>) 15 recognizes that the test packet is addressed to its own node according to a destination address (#n) 12 and the test packet identifier 11, and generates a test response packet 13.

The destination node (#n) 2 obtains a difference between a time Tn 14 when transmitting the test response packet 13 and a time Rm 16 when receiving a test packet (2-<n−1>) 15 to calculate a relay delay time (#n) 17 at the destination node (#n) 2. Then, the destination node (#n) 2 adds a node No. (#n) 18 of the destination node (#n) 2 and the calculated relay delay time (#n) 17 at the destination node (#n) 2 to the test response packet 13. Also, the destination node (#n) 2 copies a source address (#0) 19 of the test packet (2-<n−1>) 15 into a destination address 20 of the test response packet (2-<n>) 13, and copies a destination address (#n) 12 of the test packet (2-<n−1>) 15 into a source address 21. Further, as illustrated in FIG. 4A, the destination node (#n) 2 replaces a test packet identifier 11 in the test packet with a test response packet identifier 22 in the test response packet 13 to generate a test response packet (2-<n>) 13, and returns the test response packet (2-<n>) 13 to the source node (#0) 1.

When receiving the test response packet (2-<n>) 13, each of the respective relay nodes (#n−1) to (#1) reaching from the destination node (#n) 2 to the source node (#0) 1 recognizes that the test response packet (2-<n>) 13 is a test response packet according to the test response packet identifier 22, and transfers the test response packet (2-<n>) 13 to a next node without processing the test response packet (2-<n>) 13.

In this example, if relay delay times at the respective nodes during returning are also intended to be acquired, the destination node (#n) 2 returns the test packet identifier 11 as it is, as a test response packet, as illustrated in FIG. 4B, without replacing the test packet identifier 11 with the test response packet identifier 22. As a result, the relay delay times during returning can be also acquired.

Also, if only the relay delay times at the respective nodes during returning are intended to be acquired, a dedicated identifier for measurement only during returning is added to the test packet identifier 11, to thereby measure the relay delay times only during returning. As a result, a test response packet exemplified in FIG. 4C in which only delay times each of which is a difference between a transmission time and a reception time are added to the test response packet can be provided.

In this example, as exemplified in FIGS. 5A to 5C, the source node (#0) 1 can change a priority 23 used for priority control during node relay, which is added to the test packet, to thereby also measure the relay delay times of the packet with the respective priorities at the relay nodes and the destination node.

As illustrated in FIG. 6, the source node (#0) 1 includes a packet transmitter and receiver part 24, a test packet detection part 25, a test packet generation part 26, a test packet control part 27, a state monitor database part 28, an abnormal state detection part 29, and a display/storage part 30.

The source node (#0) 1 receives the test response packet (2-<n>) 13 by the packet transmitter and receiver part 24, and recognizes the test response packet, which collects the delay times of the respective nodes, according to the test packet identifier 11 and the test response packet identifier 22, which are addressed to the source node (#0), by the test packet detection part 25. When the test response packet that has collected the delay times of the respective nodes is recognized by the test packet detection part 25, the source node (#0) 1 extracts transmission directions (go and back) of the packet, node Nos. (#1 to #n) of the respective nodes, the priority 23 of the packet, and the delay times of the respective nodes, from the test response packet (2-<n>) 13 by the test packet control part 27, and saves the extracted data in the state monitor database part 28. An example of the database in the state monitor database part 28 that saves the extracted data therein is illustrated in FIG. 7.

Subsequently, the operation of detecting a node in which abnormality occurs according to the acquired relay delay time will be described with reference to FIGS. 6 to 10.

Referring to FIG. 6, the abnormal state detection part 29 determines a threshold value of the relay delay time for detecting the node as the abnormal node with reference to the delay time from the state monitor database part 28. For example, the abnormal state detection part 29 automatically calculates 3σ (σ is a standard deviation), and sets the determined threshold value as a threshold value 31 as illustrated in FIG. 8. As a result, a node #m whose relay delay time exceeds the set threshold value 31 is detected as the abnormal node, and saved in the display/storage part 30. In this example, the threshold value may be manually set.

As illustrated in FIGS. 9 and 10, the test packet is periodically transmitted to acquire the relay delay time of each node, and the threshold value for determining an abnormal value of the relay delay time for each node is automatically calculated according to the acquired relay delay time. As a result, not only a steady abnormal node but also a transient abnormal node can be detected. In this example, the threshold value may be manually set.

In this way, the source node transmits the test packet so as to grasp the relay delay time for each direction (go and back) of the packet transmission, each node, and each priority. Further, the source node automatically calculates or manually sets the threshold value of the relay delay time for detecting the abnormal node so as to immediately detect the abnormal node by only one transmission of the test packet. Further, the source node periodically transmits the test packet, and automatically calculates or manually sets the threshold value according to the acquired relay delay time so as to immediately detect not only the steady abnormal node but also the abnormality that transiently occurs.

### Second Embodiment

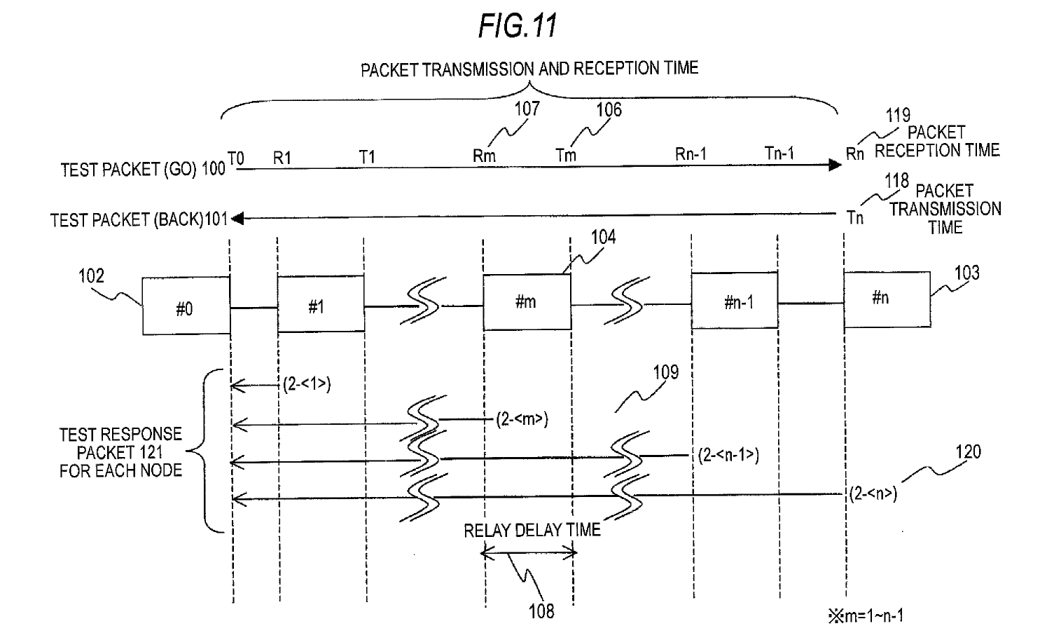

Hereinafter, a second embodiment will be described with reference to FIGS. 11 to 13.

In the first embodiment, because the node No. and the relay delay time are additionally recorded in the relay node, there is a possibility that a processing time for additional recording is added while relaying the test packet, resulting in such a problem that a proper relay delay time cannot be measured. Under the circumstances, in the second embodiment, instead of the method in which the node No. and the delay time are recorded in the test packet in the first embodiment, the test response packet is transmitted for each node so that the accurate relay delay time can be acquired with elimination of the processing time for additional recording. The method in which the source node extracts the relay delay time and detects the abnormal node is identical with that in the first embodiment, and therefore its description will be omitted.

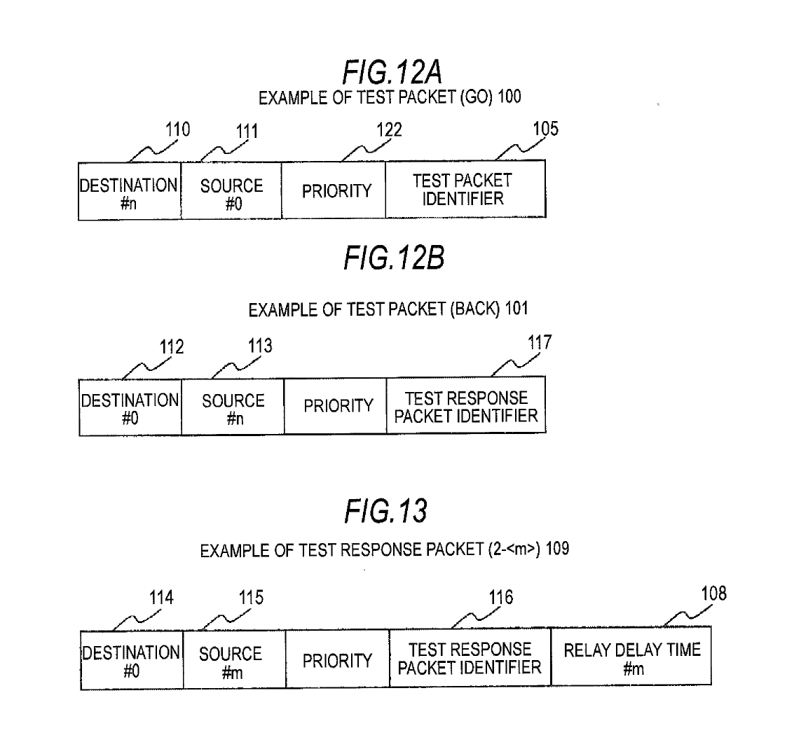

Referring to FIG. 11, a source node (#0) 102 that monitors a network state adds an identifier 105 of the test packet to a test packet (go) 100 illustrated in FIG. 12, and transmits the test packet 100 to a destination node (#n) 103.

A relay node (#m) 104 that has received the test packet (go) 100 recognizes that the received packet is a test packet according to the identifier 105, and obtains a difference between a time Tm 106 when transmitting the test packet (go) 100 and a time Rm 107 when receiving the test packet (go) 100 to calculate a relay delay time (#m) 108.

Further, as illustrated in FIG. 13, the relay node (#m) 104 generates a test response packet (2-<m>) 109, and returns the test response packet (2-<m>) 109. The test response packet (2-<m>) 109 includes a source address (#0) 111 of the test packet (go) 100 as a destination address (#0) 114, and the relay node (#m) 104 as a source address (#m) 115, and has a test response packet identifier and the relay delay time (#m) 108 at the relay node (#m) 104 added thereto.

The above-mentioned overall operation of the relay node (#m) 104 is implemented by all of the relay nodes (m=1 to n−1) that conduct relay operation.

In this example, the test packet (go) 100 is transferred as it is until arriving at the destination node (#n) 103 without processing data in the relay node.

The destination node (#n) 103 that has received the test packet (go) 100 recognizes that the received test packet (go) 100 is a test packet addressed to its own node according to a destination address (#n) 110 and the identifier 105. The destination node (#n) 103 then copies a source address (#0) 111 of the test packet (go) 100 into a destination address 112 of a test packet (back) 101 as the destination address (#0) 112, and copies a destination address (#n) 110 of the test packet (go) 100 into a source address 113 of the test packet (back) 101 as the source address (#n) 113. Further, as illustrated in FIG. 12A, destination node (#n) 103 replaces a test packet identifier 105 of the test packet (go) 100 with a test response identifier 117 in the test packet (back) 101 to generate and transmit the test packet (back) 101.

Further, the destination node (#n) 103 obtains a difference between a time (Tn) 118 when transmitting the test packet (back) 101 and a time (Rn) 119 when receiving the test packet (go) 100 to calculate a relay delay time (#n). Also, the destination node (#n) 103 generates a test response packet (2-<n>) 121, and returns the test response packet (2-<n>) 121. The test response packet (2-<n>) 121 includes a source address (#0) 111 of the test packet (go) 100 as a destination address, and its own node (#n) 103 as a source address, and also has a test response packet identifier and the obtained relay delay time (#n) added thereto. A packet format of the test response packet (2-<n>) 121 is identical with the test response packet (2-<m>) 109 (refer to FIG. 13).

Each relay node (#m) 104 that has received the test packet (back) 101 and the test response packet 121 of each node (refer to FIG. 11) recognizes that the received test response packet 121 is a test response packet according to the test response identifiers 116 and 117, and transfers the test packet (back) 101 and the test response packet 121 without any processing.

In this example, if a relay delay time at each node during returning is intended to be acquired, the destination node (#n) 103 adds a dedicated identifier for return measurement to the test packet (back) as the test response packet identifier 117, and transmits the test packet, thereby enabling the relay delay time during returning to be acquired. In this case, the relay node (#m) 104 that has received the test packet (back) recognizes that there is a need to measure the relay delay time during returning according to the test response packet identifier, and measures the relay delay time in the same manner as that described above. The relay node (#m) 104 then generates a test response packet having a destination address and a source address which are identical with the destination address 114 and the source address 115 of the test packet (back), and having the measured relay delay time added thereto, and returns the generated test response packet.

Also, if only the relay delay time during returning is intended to be acquired, a dedicated identifier for measurement only during returning is added to the test packet identifier 105 as in the above-mentioned first embodiment, to thereby measure the relay delay time only during returning and return the measured relay delay time.

Further, as in the first embodiment, as illustrated in FIG. 12, the source node (#0) 102 can change a priority 122 used for priority control during node relay, which is added to the test packet (go) 100, to thereby also measure the relay delay times of the packet with the respective priorities at the relay node and the destination node.

In the first embodiment, the relay delay times of all the nodes can be measured by one test packet. On the other hand, in this embodiment, because each node transmits the test response packet, there arises such a problem that a load on the network is temporarily increased. Under the circumstances, the test response packet is transmitted for each node at random or after a given wait time has elapsed so that the load on the network can be reduced. For example, the wait time is set to a value that is automatically calculated according to each node No. whereby the load on the network can be reduced.

### Third Embodiment

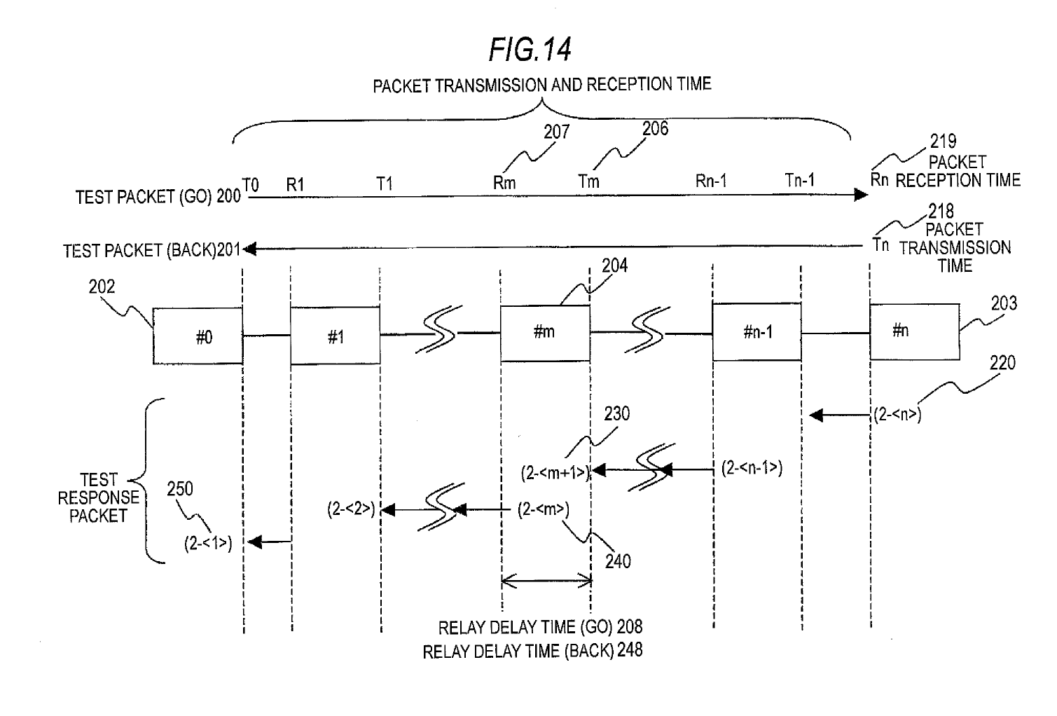

Hereinafter, a third embodiment will be described with reference to FIGS. 14 to 16A, 16B.

In the second embodiment, as compared with the first embodiment, there arises such a problem that the load on the network is increased because the test response packet is transmitted for each node. Under the circumstances, in the third embodiment, instead of transmission of the test response packet for each node, the destination node collects the relay delay times of the respective nodes so as to reduce the load on the network. The method of extracting the relay delay time and detecting the abnormal node in the source node is identical with that of the first and second embodiments, and therefore its description will be omitted. Also, the relay method and the generation method of the test packet (go) and the test packet (back) are also identical with those in the second embodiment, and therefore their description will be omitted.

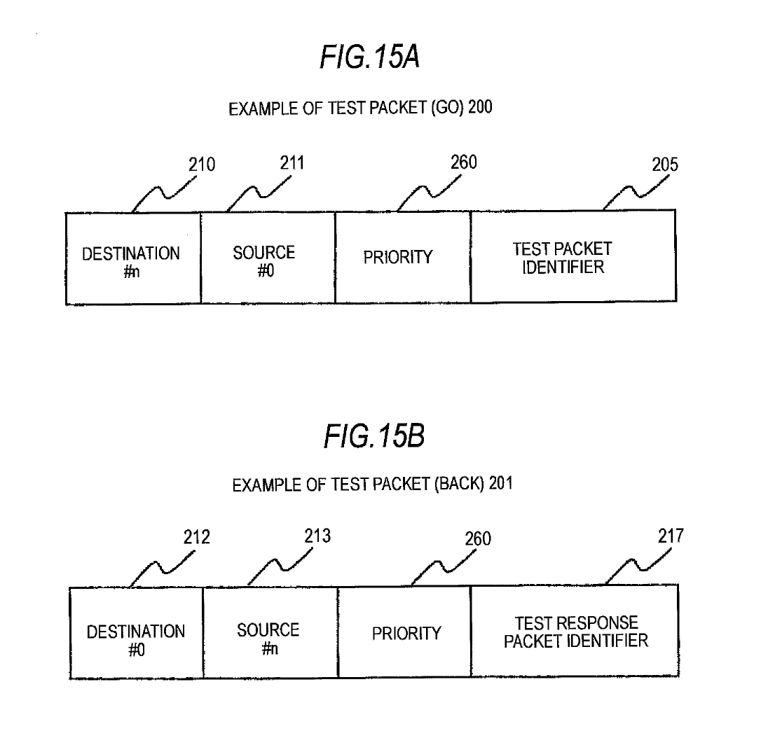

Referring to FIG. 14, a source node (#0) 202 that monitors the network state adds an identifier 205 of the test packet to a test packet (go) 200 illustrated in FIG. 15, and transmits the test packet 200 to a destination node (#n) 203.

A relay node (#m) 204 that has received the test packet (go) 200 recognizes that the received packet is a test packet according to the identifier 205, and obtains a difference between a time (Tm) 206 when transmitting the test packet (go) 200 and a time (Rm) 207 when receiving the test packet (go) 200 to calculate a relay delay time (#m) 208. In this example, the test packet (go) 200 is transferred as it is until arriving at the destination node (#n) 203 without processing data in the relay node.

The destination node (#n) 203 that has received the test packet (go) 200 recognizes that the received test packet (go) 200 is a test packet addressed to its own node according to a destination address (#n) 210 and the test packet identifier 205. The destination node (#n) 203 then copies a source address (#0) 211 of the test packet (go) 200 into a destination address 212 of a test packet (back) 201 as the destination address (#0) 212, and copies a destination address (#n) 210 of the test packet (go) 200 into a source address 213 as the source address (#n) 213. Further, as illustrated in FIG. 15B, destination node (#n) 203 replaces a test packet identifier 205 of the test packet (go) 200 with a test response packet identifier 217 in the test packet (back) 201 to generate and transmit the test packet (back) 201.

Further, the destination node (#n) 203 obtains a difference between a time (Tn) 218 when transmitting the test packet (back) 201 and a time (Rn) 219 when receiving the test packet (go) 100 to calculate a relay delay time (#n) 222. Also, the destination node (#n) 203 generates a test response packet (2-<n>) 220, and returns the test response packet (2-<n>) 220. The test response packet (2-<n>) 220 includes a source address (#0) 211 of the test packet (go) 200 as a destination address, and its own node (#n) 204 as a source address, and also has the own node No. (#n) 203, a test response packet identifier 221, and the obtained relay delay time (#n) 222 added thereto.

The relay node (#m) 204 that has received the test packet (back) 201 recognizes that the received test response packet 201 is a test response packet according to the test response packet identifier 217, and transfers the test packet (back) 201 without any processing.

Also, the relay node (#m) 204 that has received the test response packet (2-<m+1>) 230 recognizes that the received test response packet (2-<m+1>) 230 is a test response packet according to a test response packet identifier 221. The relay node (#m) 204 adds a relay delay time (#m) 208 calculated during relaying the test packet (go) 200 and the own node No. (#m) 204 to the test response packet (2-<m+1>) 230, and generates a test response packet (2-<m>) 240. The relay node (#m) 204 then transfers the generated test response packet (2-<m>) 240 to the source node 202.

In this example, if relay delay times at the respective nodes during returning are intended to be acquired, the relay node (#m) 204 adds a dedicated identifier for go and return measurement to the test packet identifier 205 of the test packet (go) 200, thereby enabling the relay delay time during returning (back) to be acquired. In this case, the destination node (#n) 203 recognizes that there is a need to also measure the relay delay time during returning according to the test packet identifier 205 of the test packet (go) 200. The destination node (#n) 203 then adds a dedicated identifier for return measurement to the test response packet identifier 217 of the test packet (back) 201, and transmits the test packet (back) 201, thereby enabling the relay delay time during returning to be also acquired. The relay node (#m) 204 that has received the test packet (back) 201 recognizes that there is a need to also measure the relay delay time during returning according to the identifier 217 of the test response packet of the test packet (back) 201, and measures the relay delay time. The relay node (#m) 204 that has received the test response packet (2-<m+1>) 230 recognizes that the received test response packet (2-<m+1>) 230 is a test response packet according to the test response packet identifier 221. The relay node (#m) 204 then adds the relay delay times (#m) 208 and 248 calculated during relaying the test packet (go) 200 and the test packet (back), and its own node No. (#m) 204 to the test response packet (2-<m+1>) 230, and generates a test response packet (2-<m>) 240. The relay node (#m) 204 then transfers the generated test response packet (2-<m>) 240 to the source node (#0) 202.

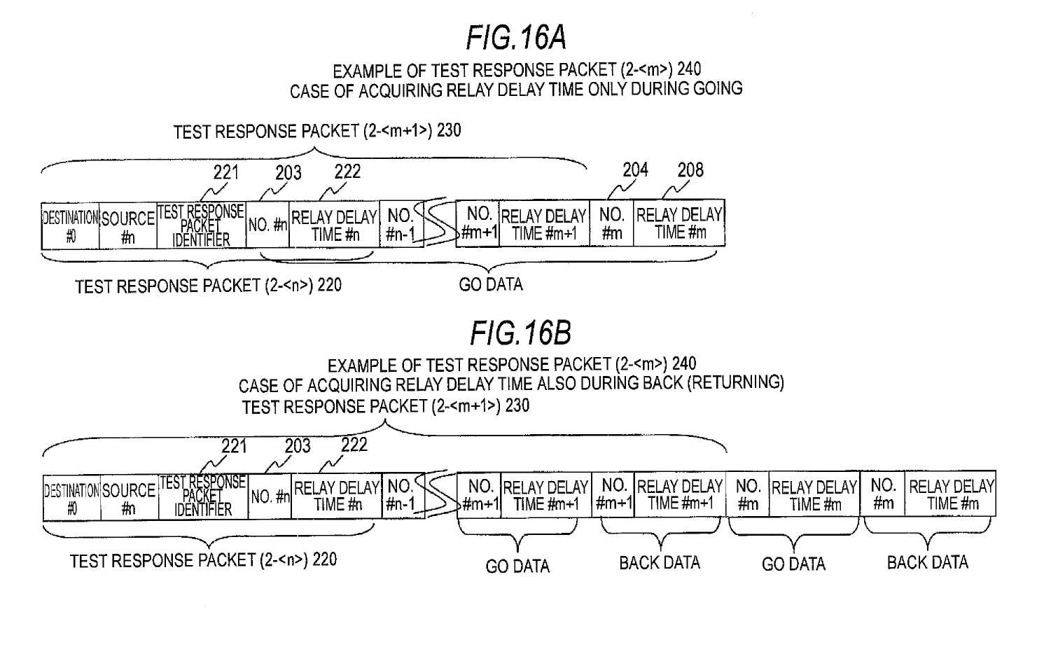

FIGS. 16A and 16B illustrate cases of the test response packet (2-<m>) 240 in the relay node (#m) 204.

FIG. 16A exemplifies a case of the test response packet (2-<m>) 240 in which the relay delay time is acquired during only go, and FIG. 16B exemplifies a case of the test response packet (2-<m>) 240 in which the relay delay time is also acquired during returning (back).

Also, if only the delay time during returning is intended to be acquired, a dedicated identifier for measurement only during returning is added to the test packet identifier 205 of the test packet (go), to thereby enable the relay delay time only during returning (back) to be acquired. In this case, the relay node (#m) 204 does not measure the relay delay time during relaying the test packet (go), and the destination node (#n) 203 that has received the test packet (go) 200 recognizes that there is a need to measure the relay delay time only during returning according to the test packet identifier 205 of the test packet (go) 200. The destination node (#n) 203 adds a dedicated identifier for measurement during returning to the test response packet identifier 217 of the test packet (back) 201, and transmits the test packet 201, thereby enabling the relay delay time only during returning to be acquired.

Further, as in the first and second embodiments, as illustrated in FIG. 15, the source node (#0) 202 can change a priority 260 used for priority control during node relay, which is added to the test packet (go) 200, to thereby also measure the relay delay times of the packet with the respective priorities at the relay node and the destination node.

The second embodiment suffers from such a problem that the test response packet is transmitted by the respective nodes to increase the load on the network. On the contrary, the relay delay times of all the nodes can be immediately acquired by only two frames of the test packet and the test response packet, thereby enabling an accurate relay delay time to be acquired without increasing the load on the network.

In FIGS. 1 to 16A, 16B, the same reference symbols denote identical or corresponding parts.

The features of the above-mentioned first to third embodiments are described below.

Feature 1: In a network state monitoring system that monitors a state of a network, a test packet is transmitted from a communication device (hereinafter referred to as “source node”) that monitors the network state to a receiver device (hereinafter referred to as “destination node”) through respective relay devices (hereinafter referred to as “relay nodes”), the relay node adds a relay delay time of each relay node to the test packet, the destination node returns the test packet (hereinafter referred to as “test response packet”) to the source node, and the source node receives the test response packet returned by the destination node, extracts the relay delay time of each node from the test response packet, and detects an abnormal node according to the extracted relay delay time of each node.
Feature 2: Tn the feature 2, the source node adds a test packet identifier to the test packet when transmitting the test packet so that each node can identify that the packet is the test packet.
Feature 3: In the features 1 and 2, the relay node recognizes that the test packet has been received according to the test packet identifier, and adds the relay delay time of each relay node to the test packet during relaying the test packet.
Feature 4: In the features 1 and 2, the relay node transfers the test packet without processing the test packet when the test packet identifier is an identifier indicating no need to add the relay delay time.
Feature 5: In the features 1 to 4, when returning the test packet, the destination node copies the destination address of the test packet into the source address of the test response packet, and copies the source address of the test packet into the destination address of the test response packet.
Feature 6: In the features 1 to 5, when transmitting the test packet, the destination node adds the relay delay time of the destination node to the test response packet.
Feature 7: In the features 1 to 6, the source node changes a priority used for priority control during node relay, which is added to the test packet to measure the relay delay times of the packet with the respective priorities at the relay nodes and the destination node.
Feature 8: In the features 1 to 7, the source node periodically transmits the test packet to periodically acquire the relay delay time of each node, and automatically calculates or manually sets a threshold value for determining an abnormal value of the relay delay time for each node according to the acquired relay delay time, to thereby enable not only a steady abnormal node but also a transient abnormal node to be detected.
Feature 9: In a network state monitoring system that monitors a state of a network, test packets are transmitted from a source node to a destination node through respective relay nodes, the respective relay nodes and the destination node, which have received the test packets, each transmit a test response packet added with a relay delay time to the source node, the source node receives the test response packets transmitted from the respective relay nodes and the destination node, extracts the relay delay times of the respective nodes from the test response packets, and detects an abnormal node according to the extracted relay delay times of the respective nodes.
Feature 10: In the feature 9, the respective relay nodes and the destination node each transmit the test response packet at random or after a given wait time has elapsed so that the load on the network can be reduced.
Feature 11: In a network state monitoring system that monitors a state of a network, test packets are transmitted from a source node to a destination node through respective relay nodes, the respective relay nodes and the destination node, which have received the test packets, each calculate a relay delay time, the destination node adds the relay delay time of the destination node to a test response packet, and transmits the added test response packet, each relay node that has received the test response packet adds the relay delay time calculated when receiving the test packet to the test response packet, and transmits the added test response packet, the source node receives the test response packet, extracts the relay delay time of each node from the test response packet, and detects an abnormal node according to the extracted relay delay time of each node.
Feature 12: When monitoring the network state, even if clock times of the respective nodes are asynchronous with each other, the source node can accurately measure the delay time of each node, and measure the delay time for each priority of the packet, and the source node can immediately grasp the network state by automatically recognizing whether the acquired delay time is normal or abnormal, thereby obtaining a state monitoring method for specifying a faulty portion.
Feature 13: A test packet is transmitted from a source node that monitors a network state to a destination node through respective relay nodes, the relay nodes and the destination node each measure the relay delay time, and add the measured relay delay time to a test response packet, and the source node receives the test response packet, extracts the relay delay time of each node from the test response packet, and immediately detects an abnormal node according to the extracted relay delay time of each node.
Feature 14: The delay time of each node can be accurately measured, the delay time can be measured for each priority of the packet, and a faulty portion of the network can be immediately specified by automatically recognizing whether the acquired delay time is normal or abnormal.
Feature 15: A test packet is transmitted from a source node that monitors a network state to a destination node through respective relay nodes, the relay nodes and the destination node each measure the relay delay time, and add the measured relay delay time to a test response packet, and the source node receives the test response packet, extracts the relay delay time of each node from the test response packet, and automatically detects an abnormal node according to the extracted relay delay time of each node.
Feature 16: In a network state monitoring system that monitors a state of a network which conducts communication between a source node and a destination node through a plurality of relay nodes, a test packet is transmitted from the source node to the destination node through the respective relay nodes, a relay delay time of each relay node measured in the relay node is added to the test packet, the source node is designated as a destination of the test packet received in the destination node to return the test packet as the test response packet, the source node that has received the test response packet extracts the relay delay time of the each node from the received test response packet, and an abnormal node is detected by an abnormal state detector disposed in the source node according to the extracted relay delay time of the each node.
Feature 17: In the feature 16, the source node adds a test packet identifier to the test packet so that the each node can identify the test packet, and transmits the test packet.
Feature 18: In the feature 17, when receiving the test packet, the each relay node determines the test packet identifier of the received test packet, and if the each relay node recognizes that the test packet has been received, the each relay node adds the relay delay time of the each node to the test packet and transmits the test packet when relaying the test packet.
Feature 19: In the feature 17, when receiving the test packet, the each relay node determines the test packet identifier of the received test packet, and if the test packet identifier of the received test packet is an identifier indicating no need to add the relay delay time of the each node, the each relay node transfers the received test packet without processing the received test packet.
Feature 20: In any one of the features 15 to 19, when returning the test packet as the test response packet, the destination node copies the destination address of the test packet into the source address of the test response packet, and copies the source address of the test packet into the destination address of the test response packet.
Feature 21: In any one of the features 15 to 20, when returning the test packet as the test response packet, the destination node adds the relay delay time of the destination node to the test response packet.
Feature 22: In any one of the features 15 to 21, the source node changes a priority used for priority control during node relay, which is added to the test packet, to measure the relay delay times of the packet with the respective priorities at the relay nodes and the destination node.
Feature 23: In any one of the features 15 to 22, the source node periodically transmits the test packet to periodically acquire the relay delay time of each node, and automatically calculates or manually sets a threshold value for determining an abnormal value of the relay delay time for each node according to the acquired relay delay time, to thereby enable not only a steady abnormality but also a transient abnormality to be detected.
Feature 24: In a network state monitoring system that monitors a state of a network which conducts communication between a source node and a destination node through a plurality of relay nodes, a test packet is transmitted from the source node to the destination node through the respective relay nodes, the respective relay nodes and the destination node, which have received the test packet, each transmit a test response packet added with a relay delay time of each node to the source node, the source node that has received the test response packets transmitted from the respective relay nodes and the destination node extracts the relay delay time of each node from the received test response packets, and detects an abnormal node according to the extracted relay delay time of the each node by an abnormal state detection part disposed in the source node.
Feature 25: In the feature 24, the respective relay nodes and the destination node each transmit the test response packet at random or after a given wait time has elapsed.
Feature 26: In a network state monitoring system that monitors a state of a network that conducts communication between a source node and a destination node through a plurality of relay nodes, a test packet is transmitted from the source node to the destination node through the respective relay nodes, the respective relay nodes and the destination node, which have received the test packets, each calculate a relay delay time of each node, the destination node adds the relay delay time of the destination node to a test response packet, and returns the added test response packet, each of the relay nodes that have received the test response packet adds the relay delay time of each node calculated when receiving the test packet to the test response packet, and transmits the test response packet, the source node that has received the test response packet extracts the relay delay time of the each node from the received test response packet, and detects an abnormal node by an abnormal state detection part disposed in the source node according to the extracted relay delay time of the each node.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A network state monitoring system that monitors a state of a network that communicates between a source node and a destination node through a plurality of relay nodes,
wherein a test packet is transmitted from the source node to the destination node through the respective relay nodes, a relay delay time of each relay node, which has been measured in the each relay node, is added to the test packet, the source node is designated as a destination of the test packet received in the destination node to return a test response packet, the relay delay time of the each node is extracted from the test response packet received in the source node that has received the test response packet, and an abnormal node is detected by an abnormal state detector disposed in the source node according to the extracted relay delay time of the each node.

2. The network state monitoring system according to claim 1,
wherein, in the source node, a test packet identifier is added to the test packet to transmit the test packet so that the each node can identify the test packet.

3. The network state monitoring system according to claim 2,
wherein, when receiving the test packet, the each relay node determines the test packet identifier of the received test packet, and if the each relay node recognizes that the test packet is received, the each relay node adds the relay delay time of the each node to the test packet when relaying the test packet.

4. The network state monitoring system according to claim 2,
wherein, when receiving the test packet, the each relay node determines the test packet identifier of the received test packet, and if the test packet identifier of the received test packet is an identifier indicating no need to add the relay delay time of the each node, the each relay node transfers the received test packet without processing.

5. The network state monitoring system according to claim 1,
wherein when returning the test packet as the test response packet, the destination node copies the destination address of the test packet into the source address of the test response packet, and copies the source address of the test packet into the destination address of the test response packet.

6. The network state monitoring system according to claim 4,
wherein when returning the test packet as the test response packet, the destination node copies the destination address of the test packet into the source address of the test response packet, and copies the source address of the test packet into the destination address of the test response packet.

7. The network state monitoring system according to claim 1,
wherein when returning the test packet as the test response packet, the destination node adds the relay delay time of the destination node to the test response packet.

8. The network state monitoring system according to claim 5,
wherein when returning the test packet as the test response packet, the destination node adds the relay delay time of, the destination node to the test response packet.

9. The network state monitoring system according to claim 6,
wherein when returning the test packet as the test response packet, the destination node adds the relay delay time of the destination node to the test response packet.

10. The network state monitoring system according to claim 1,
wherein the source node changes a priority used for priority control during node relay, which is added to the test packet, to measure the relay delay times of the packet with the respective priorities at the relay nodes and the destination node.

11. The network state monitoring system according to claim 7,
wherein the source node changes a priority used for priority control during node relay, which is added to the test packet, to measure the relay delay times of the packet with the respective priorities at the relay nodes and the destination node.

12. The network state monitoring system according to claim 8,
wherein the source node changes a priority used for priority control during node relay, which is added to the test packet, to measure the relay delay times of the packet with the respective priorities at the relay nodes and the destination node.

13. The network state monitoring system according to claim 9,
wherein the source node changes a priority used for priority control during node relay, which is added to the test packet, to measure the relay delay times of the packet with the respective priorities at the relay nodes and the destination node.

14. The network state monitoring system according to claim 1,
wherein the source node periodically transmits the test packet to periodically acquire the relay delay time of the each node, and automatically calculates or manually sets a threshold value for determining an abnormality of the relay delay time for each node according to the acquired relay delay time to detect a steady abnormality and a transient abnormality.

15. The network state monitoring system according to claim 10,
wherein the source node periodically transmits the test packet to periodically acquire the relay delay time of the each node, and automatically calculates or manually sets a threshold value for determining an abnormality of the relay delay time for each node according to the acquired relay delay time to detect a steady abnormality and a transient abnormality.

16. The network state monitoring system according to claim 11,
wherein the source node periodically transmits the test packet to periodically acquire the relay delay time of the each node, and automatically calculates or manually sets a threshold value for determining an abnormality of the relay delay time for each node according to the acquired relay delay time to detect a steady abnormality and a transient abnormality.

17. The network state monitoring system according to claim 12,
wherein the source node periodically transmits the test packet to periodically acquire the relay delay time of the each node, and automatically calculates or manually sets a threshold value for determining an abnormality of the relay delay time for each node according to the acquired relay delay time to detect a steady abnormality and a transient abnormality.

18. The network state monitoring system according to claim 13,
wherein the source node periodically transmits the test packet to periodically acquire the relay delay time of the each node, and automatically calculates or manually sets a threshold value for determining an abnormality of the relay delay time for each node according to the acquired relay delay time to detect a steady abnormality and a transient abnormality.

19. A network state monitoring system that monitors a state of a network which conducts communication between a source node and a destination node through a plurality of relay nodes,
wherein a test packet is transmitted from the source node to the destination node through the respective relay nodes, the respective relay nodes and the destination node, which have received the test packet, each transmit a test response packet added with a relay delay time of each node to the source node, the source node that has received the test response packets transmitted from the respective relay nodes and the destination node extracts the relay delay time of each node from the received test response packets, and detects an abnormal node according to the extracted relay delay time of the each node by an abnormal state detection part disposed in the source node.

20. The network state monitoring system according to claim 19,
wherein the respective relay nodes and the destination node each transmit the test response packet at random or after a given wait time has elapsed.

21. A network state monitoring system that monitors a state of a network that conducts communication between a source node and a destination node through a plurality of relay nodes,
wherein a test packet is transmitted from the source node to the destination node through the respective relay nodes, the respective relay nodes and the destination node, which have received the test packets, each calculate a relay delay time of each node, the destination node adds the relay delay time of the destination node to a test response packet, and returns the added test response packet, each of the relay nodes that have received the test response packet adds the relay delay time of each node calculated when receiving the test packet to the test response packet, and transmits the test response packet, the source node that has received the test response packet extracts the relay delay time of the each node from the received test response packet, and detects an abnormal node by an abnormal state detection part disposed in the source node according to the extracted relay delay time of the each node.
